(19) United States
(12) Patent Application Publication
(10) Pub. No.: US 2008/0192076 A1
(43) Pub. Date: Aug. 14, 2008

(54) RECORDING METHOD OF LINEAR ENCODER SCALE FOR INK JET PRINTER

(75) Inventor: Toshiyuki SUZUKI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/029,715

(22) Filed: Feb. 12, 2008

(30) Foreign Application Priority Data
Feb. 14, 2007 (JP) 2007-033239

(51) Int. Cl. B41J 29/38

(52) U.S. Cl. 347/10

(57) ABSTRACT

There is provided a recording method of a linear encoder scale for an ink jet printer which detects a recording pattern of a liner encoder scale provided on the whole circumference of a transport belt wound around rollers to output a detection signal and ejects an ink drop from an ink jet head in synchronization with the detection signal of the linear encoder scale. The recording method of a linear encoder scale for an ink jet printer includes counting the number of output signals during the transport belt goes around by a rotary encoder attached to the roller and having a resolution which is an integral multiple of a resolution of a preliminarily set print image and dividing the number of output signals by the integer to calculate the remainder, setting a number of signals of the rotary encoder for recording a pattern on the linear encoder scale so that a number of output signals corresponding to the remainder is dispersed to the whole circumference of the transport belt, and recording the pattern on the linear encoder scale in synchronization with the detection of the set number of signals.

### BACKGROUND

1. Technical Field

The present invention relates to an ink jet printer which prints a predetermined character or image by, for example, ejecting fine ink drops of liquid ink of a plurality of colors from a plurality of nozzles to form the fine particles (ink dots) on a printing medium.

2. Related Art

Such an ink jet printer has become widely used not only in an office but also by general users with the spread of a personal computer or a digital camera as is generally cheap and high quality color printing can be easily obtained.

Such an ink jet printer forms a desired printing by printing a predetermined character or image on a printing medium by forming a fine ink dot on the printing medium by ejecting (jetting) a liquid ink drop form a nozzle of the printing head (also referred to as an ink jet head) while relatively moving the printing medium and the printing head. The one in which the ink jet head is moved in the direction crossing the transporting direction of the printing medium by mounting the inkjet head on a moving body so called a carriage is generally called as a multi path type ink jet printer. On the contrary, the one in which a long ink jet head (not necessary to be integrated) is disposed in the direction crossing the transporting direction of a printing medium and which can perform printing by so called one path is generally called as a line head type ink jet printer. In particular, in the line head type ink jet printer, it has been proposed to reduce a printing time required for one printing medium by winding and extending a transport belt around and between rollers and by performing high speed printing while transporting a printing medium by the transport belt.

In order to perform high image quality printing by such an ink jet type printer, it is required to surely eject (also referred to as land) an ink drop on a target position of the printing medium. In particular, in the line head type ink jet printer, when an ink drop is ejected while transporting a printing medium, compliance of the transporting state of the printing medium by the transport belt and the timing of the ink drop ejection is important. Consequently, in the ink jet type printer, for example, described in JP-A-11-245383 in which the printing medium is moved in synchronization with the transport belt, an ink drop is to be ejected from the ink jet head in synchronization with an encoder pulse (detection signal) from a liner encoder scale provided on the transport belt. In the ink jet type printer, misalignment of a landing position of an ink drop is restrained and a high image quality printing can be provided even when the speed of the transport system of the transport belt is varied by regarding the encoder pulse pitch of the linear encoder scale as the resolution of the print image.

However, the linear encoder scale, a magnetic pattern or optical pattern is preliminarily recorded thereon, is generally connected on the whole circumference of the transport belt, so that the joint mode of the linear encoder scale is different, that is, the output mode of the encoder pulse is different depending on the circumference length of the transport belt. When the output mode of the encoder pulse is different, the landing position of an ink drop is misaligned to deteriorate the image quality of the print image. In order to solve the problem, in the ink jet printer described in JP-A-2005-350195 (hereinafter, referred to as Patent Document 2), the joint of the linear encoder scale is complemented by a signal processing by using two linear encoder sensors. Specifically, when one of the sensors is reached to the joint, the detection signal to be used is switched to the one from the other sensor to correct the switching phase difference by the positional relationship between the sensors. Note that, it is practically impossible to uniform the joint mode of the linear encoder scale when a linear encoder scale on which a pattern is preliminarily recorded is connected on the whole circumference of the transport belt.

However, in the ink jet printer described in Patent Document 2, two linear encoder sensors are required. In addition, the scale of the signal processing circuit is increased and complicated. This causes upsizing of the device and increasing of the cost.

### SUMMARY

An advantage of some aspects of the invention is that it provided a recording method of a linear encoder for an ink jet printer which does not generate a joint itself of a linear encoder scale and capable of assuring a high quality print image.

### Invention 1

According to an aspect of the invention 1, there is provided a recording method of a linear encoder scale for an ink jet printer which detects a recording pattern of a liner encoder scale provided on the whole circumference of a transport belt wound around rollers to output a detection signal and ejects an ink drop from an ink jet head in synchronization with the detection signal of the linear encoder scale. The recording method of a linear encoder scale for an ink jet printer includes counting the number of output signals during the transport belt goes around by a rotary encoder attached to the roller and having a resolution which is an integral multiple of a resolution of a preliminarily set print image and dividing the number of output signals by the integer to calculate the remainder, setting a number of signals of the rotary encoder for recording a pattern on the linear encoder scale so that a number of output signals corresponding to the remainder is dispersed to the whole circumference of the transport belt, and recording the pattern on the linear encoder scale in synchronization with the detection of the set number of signals.

According to the recording method of a linear encoder scale for an ink jet printer according to the aspect of the invention 1, occurrence of the joint itself of the linear encoder scale is prevented and a high quality print image can be assured.

### Invention 2

According to an aspect of the invention 2, the linear encoder scale is formed by a magnetic layer, and a recording pattern on the linear encoder scale is formed by different magnetic poles, and if the integer is B, the quotient of the number of output signals of the rotary encoder during the transport belt goes around divided by the integer B is A, and the remainder is C, and the quotient of the quotient A divided by the remainder C is D, the magnetic pole of the linear encoder scale is reversed for each time the number of the signals of the rotary encoder becomes ½ of the integer B as a normal pattern and the magnetic pole of the linear encoder scale is reversed when the number of the signals of the rotary encoder becomes the number obtained by adding one to ½ of the integer B for each time the normal pattern is repeated by the quotient D as a specified pattern in the recording method of a linear encoder scale for an ink jet printer of the aspect of the invention 1.

According to the recording method of a linear encoder scale for an ink jet printer of the aspect of the invention 2, the number of output signals of the rotary encoder of the remainder C obtained by dividing the number of output signals of the rotary encoder during the transport belt goes around by the integer B is evenly dispersed on the whole circumference of the transport belt and a high quality print image can be further assured.

### Invention 3

According to an aspect of the invention 3, in order to detect the number of output signals of the rotary encoder during the transport belt goes around, the linear encoder scale formed by the magnetic layer is set to any one of magnetic pole state or no magnetic pole state, a specified magnetic pole formed by the other magnetic pole is provided on one position of the linear encoder scale when the linear encoder scale is set to one magnetic pole state or a specific pole formed by any one of magnetic poles is provided on one position of the linear encoder scale when the linear encoder scale is set to no magnetic pole state, and the number of output signals of the rotary encoder during the transport belt goes around and the specified magnetic pole is detected two times is counted in the recording method of a linear encoder scale for an ink jet printer of the aspect of the invention 2.

According to the recording method of a linear encoder scale for an ink jet printer of the aspect of the invention 3, the number of output signals of the rotary encoder during the transport belt goes around can be easily and surely detected.

### BRIEF DESCRIPTION OF THE DRAWINGS

The invention will be described with reference to the accompanying drawings, wherein like numbers reference like elements.

FIG. 1 is a front view showing a first embodiment of an ink jet printer of the invention.

FIG. 2 is a plan view showing the ink jet printer of FIG. 1

FIG. 3 is an explanation drawing showing a relation of a timing for ejecting an ink drop by the ink jet printer of FIG. 1 and a linear encoder pulse.

FIGS. 4A, 4B are each an explanation drawing showing a magnetic layer provided on the outer circumferential of the transport belt of FIG. 1, a read magnetic head, and a write magnetic head.

FIG. 5 is a flow chart showing an arithmetic process for counting rotary encoder pulses during the transport belt goes around performed by a control device of the in jet printer of FIG. 1.

FIG. 6 is a flow char showing an arithmetic process for forming a linear encoder scale performed by the control device of the ink jet printer of FIG. 1.

### DESCRIPTION OF EXEMPLARY EMBODIMENTS

Next, an embodiment of an ink jet printer according to the invention will be described with reference to the accompanying drawings.

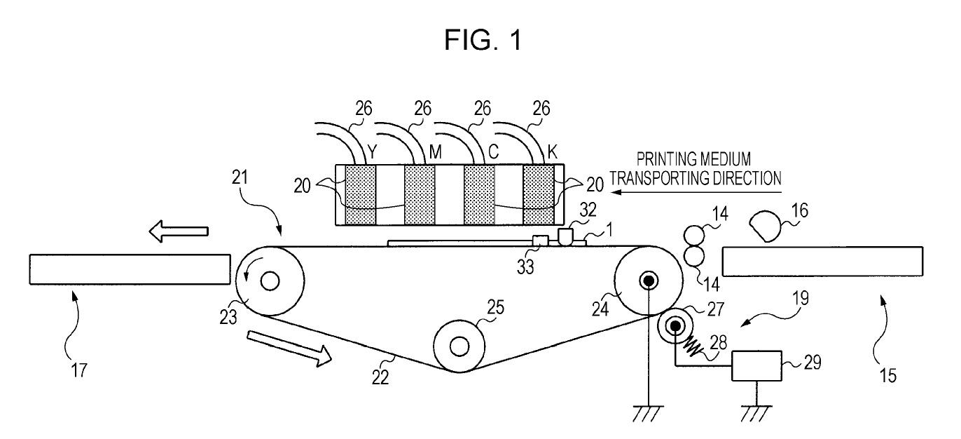

FIG. 1 is a front view schematically showing the structure of the ink jet printer of the embodiment. The ink jet printer is a line head type ink jet printer in which a printing medium 1 is transported from the right direction to the left direction as shown by the arrow of FIG. 1 and printing is performed in a printing area on the way of the transport.

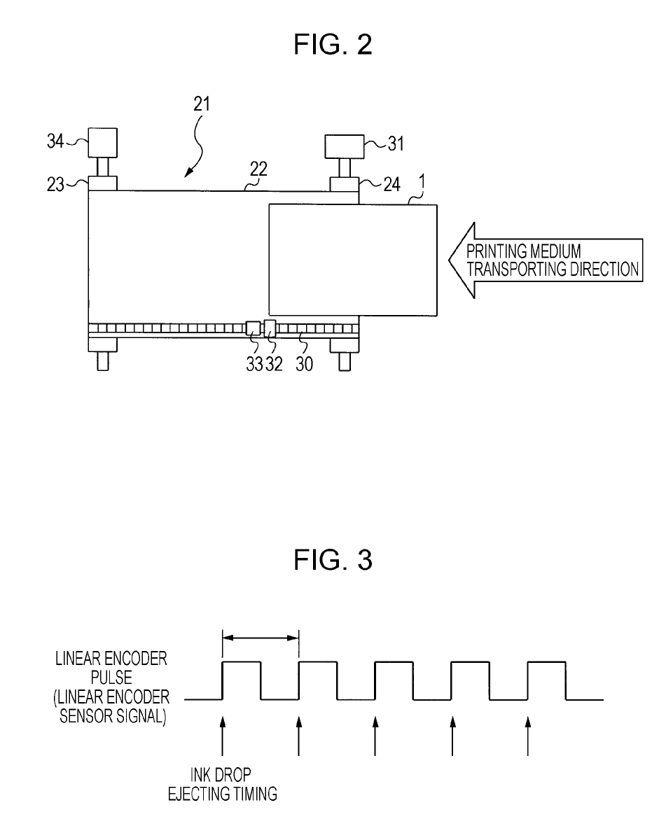

A reference numeral 20 in FIG. 1 denotes ink jet heads provided on the way of the transport of the printing medium 1. A transport unit 21 for transporting the printing medium 1 is provided below the ink jet heads 20. The transport unit 21 includes a transport belt 22. The transport belt 22 is wound around and extended between a drive roller 23 provided at the downstream side of the printing medium transporting direction, a driven roller 24 provided at the upstream side of the printing medium transporting direction, and a tension roller 25 provided below the ink jet heads 20. As shown in FIG. 2, a drive motor 34 is connected to the drive roller 23. Further, the driven roller 24 is earthed in order to charge the transport belt 22 by a charging roller described below. Further, the tension roller 25 is biased in the lower direction of FIG. 1 by a spring 12 not shown, and a tensile force (tension) is applied to the transport belt 22 by the bias force. Note that, the direction crossing the printing medium transporting direction is also referred to as a nozzle array direction. Further, the drive motor 34 is a so called step motor and is driven by a constant-speed control.

Further, a rotary encoder 31 for detecting the rotation state of the driven roller 24 is attached to the rotation axis of the driven roller 24 and a rotary encoder pulse is output from the rotary encoder 31 in synchronization with the rotation state of the driven roller 24. The rotary encoder 31 has a high resolution and generates rotary encoder pulses, for example, of about 7.2 million during the driven roller 24 goes around.

Further, a magnetic layer 30 having a fixed width is formed, for example, along the whole circumference of the transport belt 22 as shown in FIG. 2 on a part of the outer circumferential surface of the transport belt 22 formed by a high resistance member which does not make contact with the printing medium 1. A linear encoder sale is formed by alternatively magnetizing the magnetic layer 30 to reverse magnetic poles. Further, a read magnetic head 32 and a write magnetic head 33 are disposed so as to be adjacent each other on the upper side of the outer circumferential surface of FIG. 1 among the outer circumferential surface of the transport belt 22 so as to make contact with the magnetic layer (linear encoder scale) 30. The write magnetic head 33 magnetizes (records) the magnetic layer 30 to a predetermined magnetic pole and the read magnetic head 32 output a signal corresponding to the magnetic pole of the magnetic layer 30. In the embodiment, a voltage signal of Hi level is output when the magnetic pole of the magnetic layer 30 is N pole and a voltage signal of Lo level is output when S pole. That is, the read magnetic head 32 constitutes a linear encoder sensor. For example, suppose that the pitch of the rising edge of a linear encoder pulse defined by the voltage signal is the predetermined resolution of a print image, and when an ink drop is ejected from the ink jet heads 20 in synchronization with the rising edge of the linear encoder pulse, printing can be performed by a desired resolution. Note that the magnetizing method of magnetic poles on the magnetic layer 30 will be described below in detail.

The ink jet heads 20 are provided so as to be misaligned in the transporting direction of the printing medium 1 for each colors of, for example, four colors of yellow (Y), magenta (M), cyan (C), and black (K). An ink is supplied to each ink jet head 20 from an ink tank for each color not shown via an ink supply tube 26. A plurality of nozzles are formed in each ink jet head 20 in the direction crossing the transporting direction of the printing medium 1 (that is, nozzle array direction), and a fine ink dot is output and formed on the printing medium 1 by simultaneously ejecting an ink drop from the nozzle onto a needed position by a needed amount. By performing the operation for each color, printing can be performed by so called one-path in which the printing medium 1 transported by the transport unit 21 is passed for one time. That is, the area in which the ink jet heads 20 are provided corresponds to a printing area.

As for the method for ejecting and outputting an ink from each nozzle of the ink jet head, there are included an electro static system, a piezo system, a film boiling system, and the like. The electro static system is a system in which a pressure change is generated in a cavity due to the displacement of a vibrating plate in the cavity when a driving signal is applied to an electrostatic gap which is an actuator and an ink drop is ejected from a nozzle by the pressure change. The piezo system is a system in which a pressure change is generated in a cavity due to the displacement of a vibrating plate in the cavity when a driving signal is applied to a piezo element which is an actuator and an ink drop is ejected from a nozzle by the pressure change. The film boiling system is a system in which a fine heater exists in a cavity and ink is instantaneously heated to not less than 300 degrees and becomes a boiling state to generate bubbles, and an ink drop is ejected from a nozzle by the pressure change.

A pair of gate rollers 14 for adjusting a paper feed timing of the printing medium 1 supplied from a paper supply unit 15 and for correcting skew of the printing medium 1 are provided at the upstream side of the driven roller 24 in the printing medium transporting direction. The skew is a twist of the printing medium 1 with respect to the transporting direction. Further, a pick up roller 16 for supplying the printing medium 1 is provide on the upper side of the paper supply unit 15. Further, a paper discharge unit 17 is provided at the downstream side of the drive roller 23 in the printing medium transporting direction.

A belt charging device 19 is provided below the driven roller 24. The belt charging device 19 is constituted by a charging roller 27 making contact with the driven roller 24 with the transport belt 22 interposed therebetween, a spring for biasing the charging roller 27 to the transport belt 22, and a power source 29 for applying electric charge to the charging roller 27. The belt charging device 19 charges the transport belt 22 by applying electric charge from the charging roller 27. Generally, the belt is constituted by a middle-high resistive element or an insulator. Accordingly when the belt is charged by the belt charging device 19, the electric charge applied on the surface causes electric polarization of the printing medium 1 similarly constituted by a high resistive element or an insulator. Accordingly, the printing medium 1 can be absorbed on the belt by the electrostatic force generated between the electric charge generated by the electric polarization and the electric charge on the belt surface. Note that so called a corotoron for discharging electric charge may be employed as for charging means.

Accordingly, according to the ink jet printer, the printing medium 1 is electro-statically absorbed on the surface of the transport belt 22 by the effect of the electric polarization when the surface of the transport belt 22 is charged by the belt charging device 19, the printing medium 1 is supplied from the gate roller 14 in the state, and the printing medium 1 is pressed to the transport belt 22 by a paper pressing roller constituted by a gear and a roller not shown in the drawings. When the drive roller 23 is rotatably driven by the drive motor 34 in this state, the rotation driving force is transmitted to the driven roller 24 via the transport belt 22.

Printing is performed by moving the transport belt 22 on which the printing medium 1 is absorbed in this manner to the downstream side of the transporting direction to move the printing medium 1 in the lower direction of the ink jet head 20 and by ejecting an ink drop from the nozzles formed in the ink jet heads 20. When the printing is finished by the ink jet heads 20, the printing medium 1 is moved to the downstream side of the transporting direction to discharge the printing medium 1 on the paper discharge unit 17.

A control device for controlling the ink jet printer is provided in the ink jet printer. The control device is a device for performing printing operation on a printing medium by controlling an printing device, a paper feeding device, and the like based on the print data input form a host computer, for example, such as a personal computer, a digital camera, or the like. For example, as shown in FIG. 3, an ink droop is ejected from the nozzles of the ink jet heads 20 in synchronizing with the rising edge of the linear encoder pulse from the read magnetic head 32 constituting the linear encoder sensor. It should be noted here that the controlling device is constituted by an original computer system.

In the ink jet printer of the embodiment, the rotary encoder pulse number of the rotary encoder 31 during the transport belt 22 goes around is divided by a predetermined integer, a rotary encoder pulse number for recording a magnetic pattern on the magnetic layer (linear encoder scale) 30 is set so that the remainder of the rotary encoder pulse number of the rotary encoder 31 is dispersed to the whole circumference of the transport belt 22, and a magnetic pattern is recorded on the magnetic layer (linear encoder scale) 30 by the set rotary encoder pulse number by the control device.

Concretely, if the resolution of the rotary encoder 31 is an integral multiple of the resolution of the print image, the integer is B, the quotient of the rotary encoder pulse number of the rotary encoder 31 during the transport 22 belt goes around divided by the double number of the integer B is A, the remainder is C, and the quotient of the quotient A divided by the remainder C is D, the magnetic pole of the magnetic layer (linear encoder scale) 30 is reversed for each time the rotary encoder pulse number becomes the integer B as a normal pattern and the magnetic pole of the magnetic layer (linear encoder scale) 30 is reversed when the rotary encoder pulse number becomes the number obtained by adding one to the integer B for each time the normal pattern is repeated by the quotient D as a specified pattern.

Further, in order to detect the rotary encoder pulse number of the rotary encoder 31 during the transport belt 22 goes around, the magnetic layer 30 is set to any one of magnetic pole state or no magnetic pole state. When the magnetic layer 30 is set to a magnetic pole state, a specified magnetic pole formed by the other magnetic pole is provided on one position of the magnetic layer 30, and when the magnetic layer 30 is set to no magnetic pole state, a specified magnetic pole formed by any one of magnetic poles is provided on one position of the magnetic layer 30, and the rotary encoder pulse number of the rotary encoder 31 during the transport belt 22 goes around and the specified magnetic pole is detected for two times is counted.

TABLE 1

| | |
|---|---|
| Roller radius: r | 16.06 (mm) |
| Belt thickness: d | 0.10 (mm) |
| Magnetic layer thickness: x | 0.01 (mm) |
| Target scale pitch: p | 720 (dpi) = 35.278 (μm) |
| Rotary encoder pulse number: m | 7.2 million (pulse) |

Table 1 shows a specification of the ink jet printer according to the embodiment. First, the ratio of the resolution of the rotary encoder 31 and a required predetermined resolution of a print image, that is, 720 dpi of the embodiment is obtained. For example, suppose that the magnetic layer 30 is wound around the outer circumference of the driven roller 24, and when a pattern formed by the combination of different magnetic poles, that is N pole and S pole, is magnetized (recorded) at the predetermined resolution of 720 dpi on the magnetic layer 30, the ratio B of the resolution of the rotary encoder 31 and the predetermined resolution of 720 dpi of the required print image of the embodiment can be obtained by the formula (1) described below.

B=m/(π×2(r+d+x)/p)=2500 (1)

That is, the rotary encoder 31 of the embodiment has the resolution which is the integral multiple B=2500 of the predetermined resolution 720 dpi of the print image. That is, when a pattern formed by the combination of the different magnetic poles, that is N pole and S pole, is magnetized (recorded), the pole, that is N pole or S pole, is reversed for each time the rotary encoder pulses number becomes 1250 pulses, that is, ½ of the integer B as a normal pattern.

On the other hand, when the circumference length of the transport belt 22, to be precise, the whole length of the magnetic layer 30 is, for example, exactly 20 inch=508 mm, the pattern of the different magnetic poles formed on the magnetic layer 30 becomes 14400 patterns (hereinafter also referred to as a pulse as the pattern is expressed by a pulse when read out by the read magnetic head 32), so that no remainder exist in the length of the magnetic layer 30. However, for example, as also described in Patent Document 2, it is inevitable that the tolerance of the circumference length of the transport belt 22, that is, the tolerance of the whole length of the magnetic layer 30 is 0.2 to 0.3%. Accordingly the whole length of the magnetic layer 30 becomes 509.524 mm when the error is +0.3%.

When the whole length of the magnetic layer 30 is 509.524 mm, the rotary encoder 31 generates 36108000 pulses during the transport belt 22 goes around. If 36108000 is divided by the integer B=2500 pulses, the quotient becomes 14443 and the remainder becomes 500 pulses. The 14443 is the pattern (pulse) number formed by the combination of N pole and S pole recorded on the whole length of the magnetic layer 30, and set as a set write pulse number. Then, in the embodiment, the reminder 500 pulses are dispersed to the whole length of the magnetic layer 30, that is, the whole length of the transport belt 22 to prevent non uniformity of resolution. Specifically, the remainder 500 pulses are disassembled to one pulse to disperse to the whole pattern formed by the combination of N pole and S pole formed on the whole length of the magnetic layer 30. In this case, there is no change that the pattern (pulse) number formed by the combination of N pole and S pole recorded on the magnetic layer 30 is 14443 pulses, so that 28.9 is obtained by dividing the pattern (pulse) number 14443 by the remainder 500 pulses. That is, the magnetic pole reverse cycle is set to 1251 pulses of the rotary encoder pulse for each time the normal pattern formed by the combination of N pole and S pole is repeated by 29 patterns (pulses) as a specified pattern. The spacing of the specified pattern is set as a specified pattern cycle. Note that in the linear encoder recording method, the pitch of the pattern formed by the combination of N pole and S pole is set only to the increasing course. This means that it is not necessary to shorten the signal for driving a nozzle actuator or to increase the transfer speed of data, and is important for design requirement.

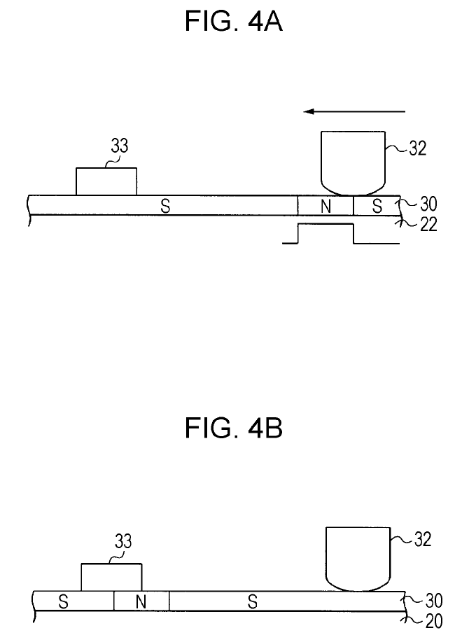

Further, in the embodiment, before the operation, the rotary encoder pulse number generated during the transport belt 22 goes around is counted. Before counting the rotary encoder pulse number, for example, as shown in FIGS. 4A, 4B, the entirety of the magnetic layer 30 is magnetized to S pole (any one of magnetic pole state) and one position is magnetized to N pole (specified magnetic pole formed by the other magnetic pole). Then, the transport belt 22 is rotated and the rotary encoder pulse number during the transport belt 22 goes around and the N pole (specified magnetic pole) is detected two times is counted by the read magnetic head 32. Note that, alternatively, the entirety of the magnetic layer 30 may be demagnetized and a specified magnetic pole formed by any one of the magnetic poles may be magnetized on one portion of the magnetic layer 30.

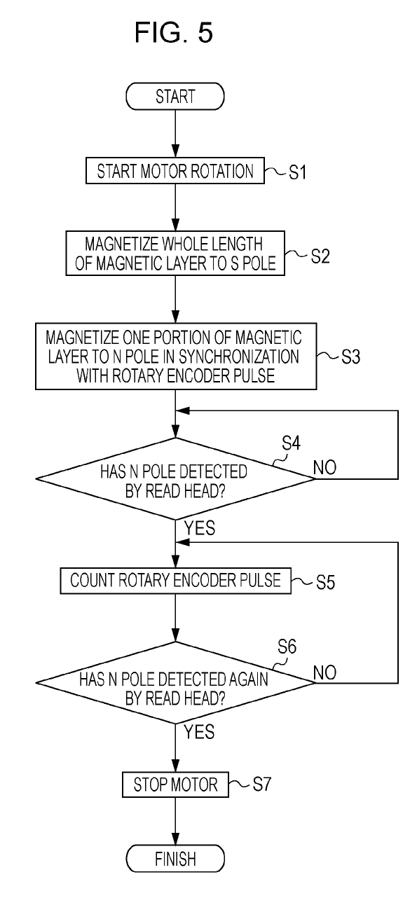

FIG. 5 shows an arithmetic process for counting the rotary encoder pulse number generated during the transport belt 22 goes around. In the arithmetic process, first, the rotation of the drive motor 34 is started in step 51.

Next, the process goes to step S2 and the whole length of the magnetic layer 30 is magnetized to S pole by the write magnetic head 33.

Next, the process goes to step S3, and one portion of the magnetic layer 30 is magnetized to N pole in synchronizing with the rotary encoder pulse by the write magnetic head 33.

Next, the process goes to step S4, and whether the N pole is detected by the read magnetic head 32 or not is judged. When the N pole is detected by the read magnetic head 32, the process goes to step S5, and when not, the step S4 is repeated.

In step S5, the rotary encoder pulse is counted.

Next, the process goes to step S6, and whether the N pole is detected again by the read magnetic head 32 or not is judged. When the N pole is detected again by the read magnetic head 32, the process goes to step S7, and when not, the process goes to step S5.

In step S7, the drive motor 34 is stopped and thereafter returned to the main program.

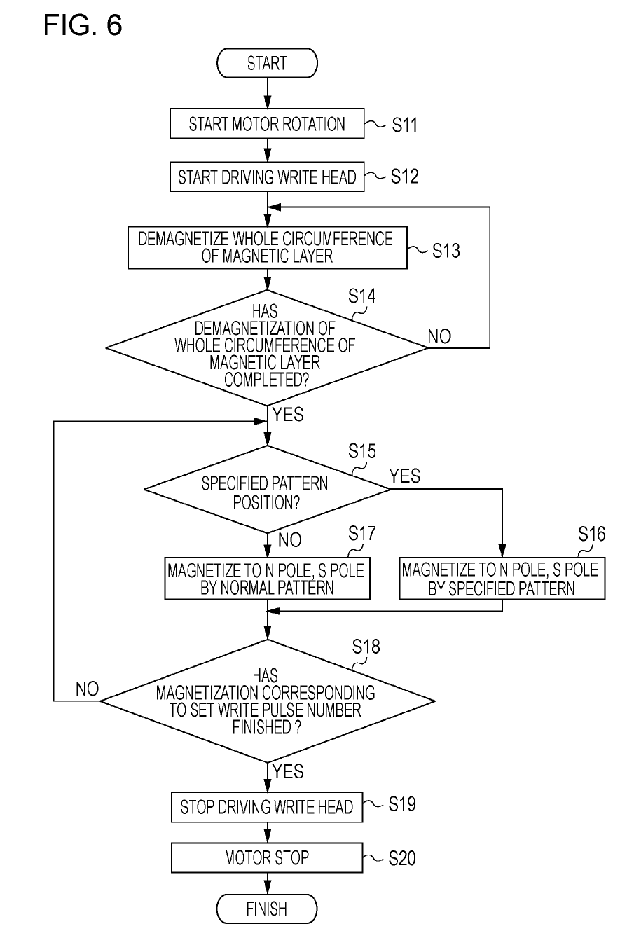

Further, FIG. 6 shows an arithmetic process for forming a linear encoder scale by magnetizing a pattern formed by the combination of N pole and S pole on the magnetic layer 30. First, the rotation of the drive motor 34 is started in step S11 in the arithmetic process.

Next, the process goes to step S12, and driving of the write magnetic head 33 is started.

Next, the process goes to step S13, and the whole circumference of the magnetic layer 30 is demagnetized by the write magnetic head 33.

Next, the process goes to S14, and whether the demagnetization of the whole circumference of the magnetic layer 30 is completed or not is judged. When the demagnetization of the whole circumference of the magnetic layer 30 is completed, the process goes to step S15, and when not, the process goes to step S13.

In step S15, as described above, whether the magnetization (recording) of the normal pattern formed by the combination of N pole and S pole is continued for 29 times and a position for the specified pattern is indicated or not is judged. When a position for the specified pattern is indicated, the process goes to step S16 and when not, goes to step S17.

In step S16, magnetization to N pole, S pole is performed by the specific pattern described above in which the magnetic pole is reversed by 1251 pulses of the rotary encoder pulse and thereafter goes to step S18.

In step S17, the magnetization to N pole, S pole is performed by the normal pattern described above in which the magnetic pole is reversed by 1250 pulses of the rotary encoder pulse and thereafter goes to step S18.

In step S18, whether the magnetization corresponding to the set write pulse number is completed or not is judged. When the magnetization corresponding to the set write pulse number is completed, the process goes to step S19, and when not, the process goes to step S15.

In step S19, the driving of the write magnetic head 33 is stopped.

Next, the process goes to step S20, and the drive motor 34 is stopped and thereafter returned to the main program.

According to the arithmetic processes, after the whole length of the magnetic layer 30 is magnetized to S pole by the write magnetic head 33, one portion of the magnetic layer 30 is magnetized to N pole in synchronization with the rotary encoder pulse, and the rotary encoder pulse number during the N pole is detected two times, that is, the transport belt 22 goes around is counted by the read magnetic head 32. After the rotary encoder pulse number during the transport belt 22 goes around is obtained, the set write pulse number, the rotary encoder pulse number of the normal pattern, the rotary encoder pulse number of the specified pattern, the specified pattern cycle are set as described above, and the whole circumference of the magnetic layer 30 is once demagnetized. Then, the magnetization to N pole, S pole by the specified pattern is performed for each time the magnetization to N pole, S pole by the normal pattern is repeated by the specified pattern cycle to form a set of liner encoder scale on the whole circumference of the magnetic layer 30.

In this manner, according to the recording method of a linear encoder scale for an ink jet printer which detects a recording pattern of a liner encoder scale provided on the whole circumference of the transport belt 22 wound around rollers 23, 24 to output a detection signal and ejects an ink drop from the ink jet head 20 in synchronization with the detection signal of the linear encoder scale on the printing medium 1 transported by the transport belt 22 of the embodiment, the rotary encoder 31 having the resolution which is an integral multiple B of a predetermined resolution of a preliminarily set print image is attached to the driven roller 24, the rotary encoder pulse number of the rotary encoder 31 during the transport belt 22 goes around is divided by the integer B, a rotary encoder pulse number for recording a pattern on the linear encoder scale is set so that the rotary encoder pulse number of the remainder is dispersed to the whole circumference of the transport belt 22, and a pattern is recorded on the linear encoder scale by the set rotary encoder pulse number. Herewith, occurrence of the joint itself of the linear encoder scale is prevented and a high quality print image can be assured.

Further, the linear encoder scale is formed by the magnetic layer 30, the recording pattern on the linear encoder scale is formed by the combination of different poles, that is N pole and S pole, and if the quotient of the rotary encoder pulse number during the transport 22 belt goes around divided by the integer B is A, the remainder is C, and the quotient of the quotient A divided by the remainder C is D, the magnetic pole of the linear encoder scale is reversed for each time the rotary encoder pulse number becomes ½ of the integer B as a normal pattern and the magnetic pole of the linear encoder scale is reversed when the rotary encoder pulse number becomes the number obtained by adding one to ½ of the integer B for each time the normal pattern is repeated by the quotient D as a specified pattern. Herewith, the rotary encoder pulse number of the remainder C obtained by dividing the rotary encoder pulse number during the transport belt 22 goes around by the integer B is evenly dispersed on the whole circumference of the transport belt 22 and a high quality print image can be further assured.

Further, in order to detect the rotary encoder pulse number during the transport belt 22 goes around, the linear encoder scale formed by the magnetic layer 30 is set to any one of magnetic pole state or no magnetic pole state. When the magnetic layer (linear encoder scale) 30 is set to a magnetic pole state, a specified magnetic pole formed by the other magnetic pole is provided on one position of the magnetic layer (linear encoder scale) 30, and when the magnetic layer (linear encoder scale) 30 is set to no magnetic pole state, a specified magnetic pole formed by any one of magnetic poles is provided on one position of the magnetic layer (linear encoder scale) 30, and the rotary encoder pulse number during the transport belt 22 goes around and the specified magnetic pole is detected for tow times is counted. Herewith, the rotary encoder pulse number during the transport belt 22 goes around can be easily and surely detected.

Note that in the embodiment, an ink drop is ejected from the nozzle of the ink jet head in synchronization with the rising edge of the detection signal of the linear encoder scale. However, an ink drop ejecting timing signal may be generated according to the detection signal of the linear encoder scale separately from the detection signal of the linear encoder scale to eject an ink drop from the nozzles of the ink jet head in synchronization with the ink drop ejecting timing signal.

Further, in the embodiment, the transport belt for transporting a printing medium is constituted by so called one transport belt having a wide width. However, the transport belt may be constituted by a group (unit) of belts in which, for example, a plurality of belts each having a narrow width are arranged in the direction crossing the printing medium transporting direction. In this case, the linear encoder scale may be directly formed on any one thereof or may be formed on a discrete belt.

Further, when a plurality of transport belts are arranged in the printing medium transporting direction, a linear encoder scale may be formed to correspond to each of the transport belts or a linear encoder scale may be integrally formed to the all of the transport belts.

Further, the ink jet printer of the invention can be applied to all types of ink jet printer which transports a printing medium by rotating rollers around which a transport belt is wound and ejects an ink drop from an ink jet head on the transported printing medium.

Further, in the embodiment, for example, after a pattern is recorded on the linear encoder scale, the both of the write magnetic head and the rotary encoder are not necessary, so that they can be detached.

Further, the transport belt on which a pattern is recorded on a linear encoder scale by the similar recording method may be embedded in a discrete ink jet printer.

What is claimed is:

1. A recording method of a linear encoder scale for an ink jet printer which detects a recording pattern of a liner encoder scale provided on the whole circumference of a transport belt wound around rollers to output a detection signal and ejects an ink drop from an ink jet head in synchronization with the detection signal of the linear encoder scale; the recording method of a linear encoder scale for an ink jet printer comprising:
counting the number of output signals during the transport belt goes around by a rotary encoder attached to the roller and having a resolution which is an integral multiple of a resolution of a preliminarily set print image and dividing the number of output signals by the integer to calculate the remainder;
setting a number of signals of the rotary encoder for recording a pattern on the linear encoder scale so that a number of output signals corresponding to the remainder is dispersed to the whole circumference of the transport belt; and
recording the pattern on the linear encoder scale in synchronization with the detection of the set number of signals.

2. The recording method of a linear encoder scale for an ink jet printer according to claim 1, wherein the linear encoder scale is formed by a magnetic layer, and a recording pattern on the linear encoder scale is formed by different magnetic poles, and if the integer is B, the quotient of the number of output signals of the rotary encoder during the transport belt goes around divided by the integer B is A, and the remainder is C, and the quotient of the quotient A divided by the remainder C is D, the magnetic pole of the linear encoder scale is reversed for each time the number of the signals of the rotary encoder becomes ½ of the integer B as a normal pattern and the magnetic pole of the linear encoder scale is reversed when the number of the signals of the rotary encoder becomes the number obtained by adding one to ½ of the integer B for each time the normal pattern is repeated by the quotient D as a specified pattern.

3. The recording method of a linear encoder scale for an ink jet printer according to claim 2, wherein in order to detect the number of output signals of the rotary encoder during the transport belt goes around, the linear encoder scale formed by the magnetic layer is set to any one of magnetic pole state or no magnetic pole state, a specified magnetic pole formed by the other magnetic pole is provided on one position of the linear encoder scale when the linear encoder scale is set to one magnetic pole state or a specific pole formed by any one of magnetic poles is provided on one position of the linear encoder scale when the linear encoder scale is set to no magnetic pole state, and the number of output signals of the rotary encoder during the transport belt goes around and the specified magnetic pole is detected two times is counted.
